(19) United States
(12) Patent Application Publication
(10) Pub. No.: US 2006/0158136 A1
(43) Pub. Date: Jul. 20, 2006

(54) Method and apparatus for DC to AC power conversion for driving discharge lamps

(75) Inventor: Wei Chen, Campbell, CA (US)

Correspondence Address: PERKINS COIE LLP;PATENT-SEA, P.O. BOX 1247, SEATTLE, WA, 98111-1247, US

(73) Assignee: Monolithic Power Systems, Inc., Los Gatos, CA (US)

(21) Appl. No.: 11/335,399

(22) Filed: Jan. 18, 2006

Related U.S. Application Data
(60) Provisional application No. 60/645,567, filed on Jan. 19, 2005.

(51) Int. Cl. H05B 41/36

(52) U.S. Cl. 315/308

(57) ABSTRACT

Methods and circuits are disclosed for converting DC power to AC power for driving discharge lamps such as cold cathode fluorescent lamps (CCFLs). Among other advantages, the lamp current and open lamp voltage can be regulated by a simple control scheme.

### CROSS-REFERENCE TO RELATED APPLICATION(S)

This application claims the benefit of U.S. Provisional Patent Application No. 60/645,567, filed on Jan. 19, 2005.

### TECHNICAL FIELD

The present invention relates, in general, to a method and apparatus for converting DC power to AC power, and more particularly, to the simple control scheme that offers stable regulation of the lamp voltage under the open lamp condition and accurate regulation of the lamp current.

### BACKGROUND

Liquid crystal display (LCD) panels used in PC monitors, TVs, and even portable DVD players use discharge lamps as backlight devices.

Commonly used discharge lamps include cold cathode fluorescent lamps (CCFLs) and external electrode fluorescent lamps (EEFLs). A DC to AC switching inverter is commonly used to power these lamps at very high AC voltage. Usually the DC voltage is chopped by power switches to produce an oscillating voltage waveform and then a transformer and filter components are used to produce a near sinusoidal waveform with sufficient amplitude. CCFLs are usually driven by AC signals having frequencies that range from 50 to 100 kilohertz.

The power switches may be bipolar junction transistors (BJT) or field effect transistors (MOSFETs). Also, the transistors may be discrete or integrated into the same package as the control circuitry for the DC to AC converter. Since resistive components tend to dissipate power and reduce the overall efficiency of a circuit, a typical harmonic filter for a DC to AC converter employs inductive and capacitive components that are selected to minimize power loss. A second-order resonant filter formed with inductive and capacitive components is referred to as a “tank” circuit, since the tank stores energy at a particular frequency. Higher order resonant filters may also be adopted.

The average life of a CCFL depends on several aspects of its operating environment. For example, driving the CCFL at a higher power level than its rating reduces the useful life of the lamp. Also, driving the CCFL with an AC signal that has a high crest factor can cause premature failure of the lamp. The crest factor is the ratio of the peak current to the average current that flows through the CCFL. On the other hand, it is known that driving a CCFL with a relatively high frequency square-shaped AC signal maximizes the useful life of the lamp. However, since the square shape of an AC signal may cause significant interference with other circuits disposed in the vicinity of the driving circuitry, the lamp is typically driven with an AC signal that has a less than optimal shape, such as a sine-shaped AC signal.

Double-ended (full-bridge and push-pull) inverter topologies are popular in driving today's discharge lamps because they offer symmetrical voltage and current drive on both positive and negative cycles. The resulting lamp current is sinusoidal and has a low crest factor. These topologies are very suitable for applications with a wide DC input voltage range.

Single-ended inverters are often considered for low-power and cost-sensitive applications. The new single-ended inverters proposed in Applications Ser. No. 10/850,351 can efficiently drive discharge lamps at low crest factor and offers much lower voltage stress than the traditional single ended inverter, is thus very attractive for the low power and cost-sensitive applications.

To achieve good regulation on both lamp current and open lamp voltage, it usually requires multiple complicate regulation loops to control the switching frequency and the duty cycle of the switching AC waveforms that are generated from the switching devices in the above mentioned inverter topologies. This invention proposes a unique and simple control scheme. The following discussion is based on the new single ended topology. However, the same control scheme can be applied to other topologies, including full bridge, half bridge and push-pull.

### BRIEF DESCRIPTION OF THE DRAWINGS

The foregoing aspects and many of the attendant advantages of the invention will become more readily appreciated as the same become better understood by reference to the following detailed description when taken in conjunction with the accompanying drawings, wherein:

FIG. 1 is a block diagram of a proposed single ended inverter circuit.

FIG. 2A is a simplified schematic diagram of an embodiment of the present invention.

FIG. 2B illustrates some waveforms under normal lamp operation conditions.

FIG. 3 illustrates feedback operation of the circuit under normal lamp conditions.

FIG. 4 illustrates feedback operation of the circuit under open lamp condition, including start-up.

FIG. 5 a simplified schematic diagram of another embodiment of the present invention.

FIG. 6 is a simplified schematic diagram of yet another embodiment using a full bridge topology.

FIG. 7 is a simplified schematic diagram of an alternative embodiment using a push-pull topology.

FIG. 8 is a simplified schematic diagram of another embodiment using a half-bridge topology.

### DETAILED DESCRIPTION

The embodiments of the present invention relate to inverter circuits and methods for converting DC power to AC power, and, specifically, to inverter circuits for driving discharge lamps such as cold cathode fluorescent lamps (CCFLs). The proposed circuits offer, among other advantages, a simple control scheme that drives either duty cycle or the switching frequency of the switching waveforms that are generated from the inverter circuits.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

The description of the embodiments of the invention and their applications as set forth herein is illustrative and is not intended to limit the scope of the invention. Variations and modifications of the embodiments are possible and practical alternatives to, or equivalents of the various elements of, the embodiments disclosed herein and are known to those of ordinary skill in the art. Such variations and modifications of the disclosed embodiments may be made without departing from the scope and spirit of the invention.

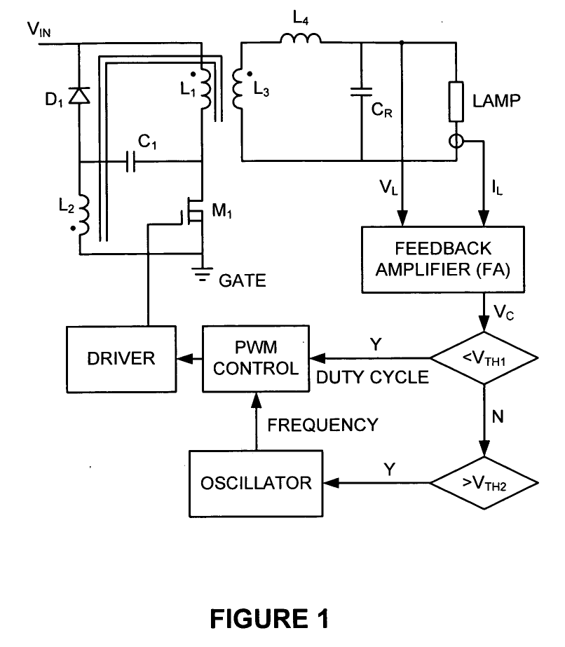

In FIGS. 1, 2A and 5-8, the combination of the four to six elements shown connected between V_{IN} and the ground may be referred to as the primary stage sub-circuit, and the combination of the two inductors and one or two capacitors in the tank circuit loop may be referred to as the secondary stage sub-circuit.

FIG. 1 is a block diagram of a single ended DC to AC inverter in accordance with an embodiment of the present invention. In this embodiment L₁, L₂, and L₃ form a 3-winding transformer. When a main switch M₁ turns on, the input source energy and the energy stored in a primary side capacitor C₁ are delivered to the secondary side. The current through the main switch M₁ is the sum of the magnetizing inductance current of the transformer and the reflected resonant inductor current in L₄. In this situation a primary side diode D₁ is off.

When the main switch M₁ turns off, the reflected L₄ current flows through the diode D₁ to continue its resonance. The drain voltage of the main switch M₁ is then brought up to Vᵢₙ+V_{C}, where V_{C} is the voltage across the capacitor C₁. Usually C₁ is designed to be large enough so that V_{C} is almost constant and equal to Vᵢₙ. Therefore, the maximum voltage stress on the main switch is about 2Vᵢₙ. The current through the diode D₁ is the sum of the magnetizing current and the reflected resonant inductor (L₄) current. Because L₄ current changes polarity, at times the net current through the diode D₁ will decrease to zero. The drain voltage of the main switch M₁ may also decrease to Vᵢₙ and oscillate around this level. The oscillation can be caused by the leakage inductance between the two primary windings and the parasitic capacitance on the primary side.

Inductors L₁, L₂, L₃ and L₄ can be integrated into one transformer. L₁ and L₂ can be wound using a bifilar structure with very good coupling coefficient. By winding the L₃ away from L₁ and L₂ windings, the leakage fluxes between the secondary winding L₃ and the primary windings (L₁ and L₂) will form L₄. The leakage fluxes may also be controlled by winding the primary windings and secondary winding on separate core legs in a 3-leg magnetic core structure.

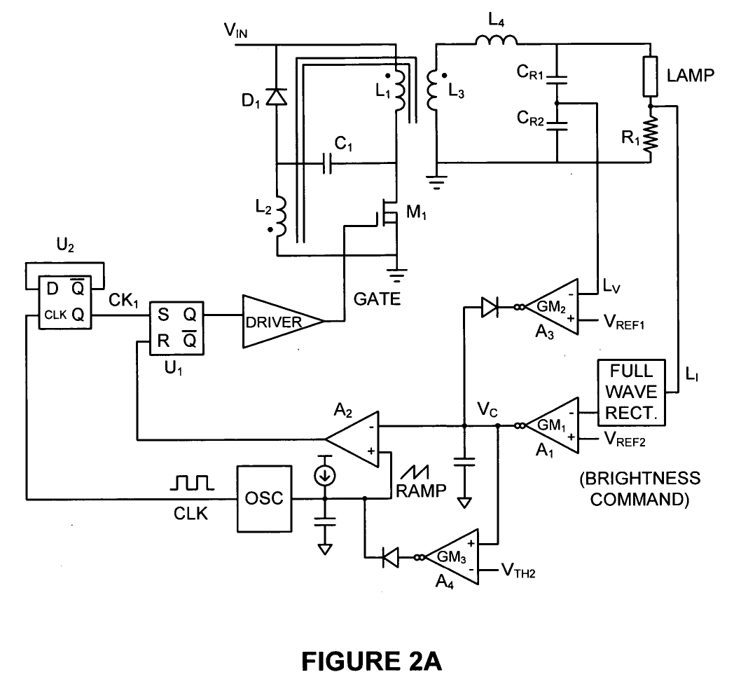

FIG. 2A shows a simplified schematic diagram of an embodiment of the present invention. The feedback amplifier output V_{C} is utilized in two control regions: V_{C}<Vₜₕ₁, and V_{C}>Vₜₕ₂, where Vₜₕ₁ and Vₜₕ₂ can be equal. However, in practical applications, it is desirable to choose Vₜₕ₂ at least 100 mV greater than Vₜₕ₁ to overcome the noise problem. One control region can be dedicated to the duty cycle control, and the other control region can be dedicated to the frequency control. For example in FIG. 2A, V_{C}<Vₜₕ₁ region is used for the duty cycle control and the V_{C}>Vₜₕ₂ region for the frequency control.

The lamp current is usually regulated to control the lamp brightness.

This current signal can be sensed via a sense resistor R₁, and then be fed into the proposed feedback amplifier block (FA). The feedback amplifier may also receive a second feedback signal, which can be the lamp voltage. In FIG. 2A, the tank capacitor Cᵣ is replaced with two series capacitors Cᵣ₁ and Cᵣ₂, and the feedback voltage is taken from the connection point of these two capacitors. The output of the feedback amplifier controls both the duty cycle and the switching frequency of M₁, which in turn modulate the lamp current, and/or the lamp voltage.

As evident from the waveforms of FIG. 2B, at duty cycles close to 50%, the voltage drive waveforms for the resonant tank L₄, C₁, and R₁ are fairly symmetrical around zero. Consequently, the lamp current, through R₁, is substantially close to sinusoidal.

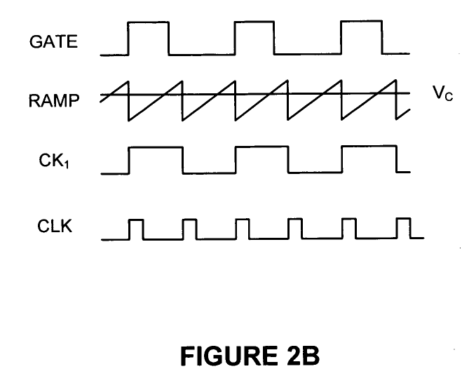

As shown in FIG. 3, under normal operation condition, the lamp current is sensed via a resistor and then is full-wave rectified. This signal is subsequently compared with the reference signal by a transconductance amplifier A₁. The output of the A₁ is typically compensated by a capacitor or a combination of the resistor and capacitor that provide the lead-lag compensation. The amplifier output V_{C} is then compared to a fix ramp voltage (Vᵣₐₘₚ) generated by the clock circuit. If the V_{C} exceeds Vᵣₐₘₚ, the comparator A₂ will reset the R-S Latch U₁ to turn off the power switch M₁. The turn-on of the power switch M₁ is initiated by the rising edge of the clock signal CK₁, which is the half frequency of the oscillator clock CLK.

The additional flip-flop U₂ is used to ensure a maximum of 50% duty cycle operation. As one can easily see from this diagram, the increase of V_{C} will result in a higher duty cycle, and thus a higher lamp current and lamp voltage.

If the lamp voltage exceeds the desired voltage level V_{REF1}, the amplifier A₃ will produce the sink-current to discharge the V_{C} pin. The average sink-current increases with the lamp voltage. This ensures the lamp voltage regulation under start-up or abnormal conditions. If V_{C} exceeds the peak of the Vᵣₐₘₚ and continues to increase above the Vₜₕ₂, it indicates that the resonant tank cannot produce enough power conversion gain to produce the desired lamp power or voltage. The switching frequency must be modulated to achieve the desires regulation. In the embodiment of FIG. 2A, the frequency will increase with V_{C} under such condition. So if a resonant tank is designed to produce higher power conversion gain at higher switching frequency, the increased frequency will eventually satisfy the regulation requirement on the lamp power or voltage.

In a practical design adopting FIG. 2A scheme, it is desired to design the switching frequency after the lamp ignition to be slightly higher than the resonant frequency. The Vₜₕ₂ should be forced to be higher than the maximum V_{C} after the lamp ignitionand will thus prevent the frequency increase even if the duty cycle reaches the maximum limit. Therefore, Vₜₕ₂ is set at different levels before and after the lamp ignition. The level of Vₜₕ₂ after the lamp ignition must be above the maximum V_{C}, and the Vₜₕ₂ before the lamp ignition is set at a level when the duty cycle reaches the maximum limit.

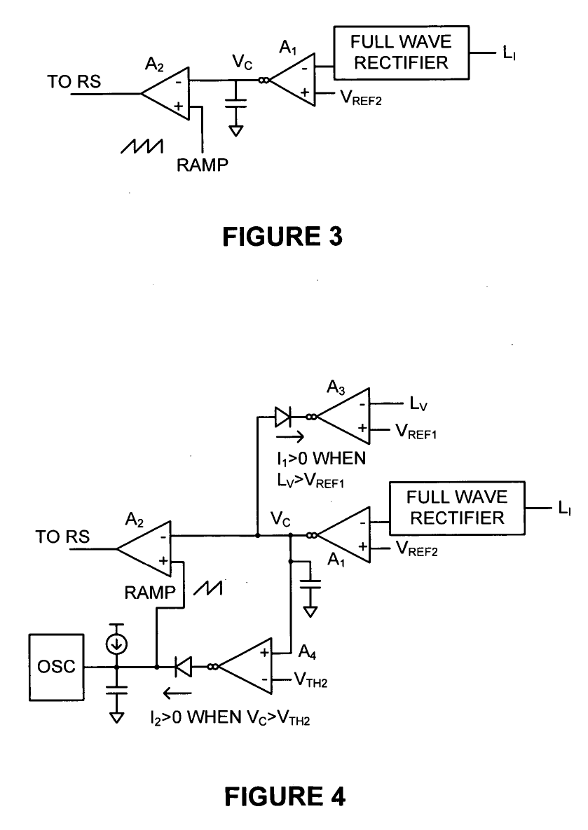

FIG. 4 illustrates feedback operation of the circuit under open lamp condition, including start-up. Under open lamp conditions, there are two possibilities. A₁ will produce higher V_{C} to increase the duty cycle and thus the lamp voltage. If the lamp voltage reaches the desired voltage commanded by V_{REF1} and the feedback back divider gain before V_{C} exceeds Vₜₕ₂, A₃ produces the pull-down current on V_{C} pin and prevents V_{C} from further increasing. Under this condition, the switching frequency will remain the same and the duty cycle is modulated to regulate the open lamp voltage. If the lamp voltage does not reach the desired regulation point when V_{C} exceeds Vₜₕ₂, the duty cycle already reaches the maximum 50%. A₄ will produce a current to increase the switching frequency if there is no lamp current. The lamp voltage is then increased because of the increased conversion gain at higher frequencies. Eventually the lamp voltage will reach the regulation point and A₁ will produce a pull-down current to regulate V_{C} and thus the frequency, to a steady state point.

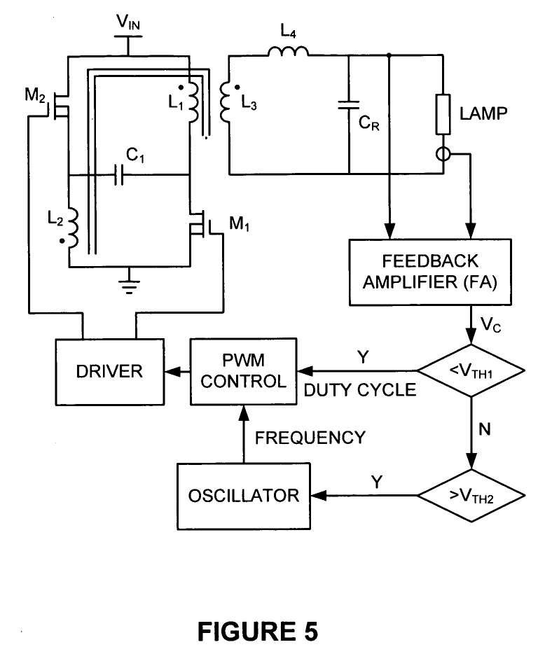

FIG. 5 shows an arrangement in which the diode D₁ is replaced with a low RDSon MOSFET (M₂). The gate control of an M₂ can be implemented in several ways. One way is to turn on the M₂ only when the current flows from the source to the drain. The resulting circuit will be similar to basic circuits shown above except that the power loss is decreased. The other way is to turn on the M₂ for the same ON time as the main switch M₁. Also interleave the M₁ and M₂ pulses like in a push-pull inverter. The resulting circuit will achieve the same symmetrical voltage and current drive for the resonant tank as the push-pull circuit. In addition, the voltage stress of the M₁ and M₂ switches will never exceed 2Vᵢₙ and no snubber is needed.

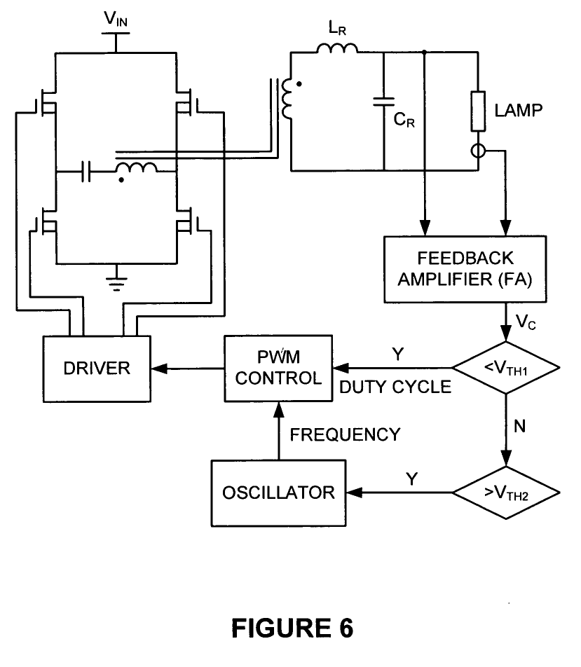

FIG. 6 is a simplified schematic diagram of yet another embodiment using a full bridge topology. In FIG. 6, on the primary side of the transformer, a first and a second transistor are connected in series between the DC input voltage and the circuit ground and a third and a forth transistor are also connected in series between the DC input voltage and the circuit ground. A series inductor and capacitor are connected between the connection point of the first and the second transistors and the connection point of the third and the forth transistors. All four transistors in this embodiment are controlled by the gate driver and the inductor forms a transformer with at least one of the windings of the tank loop.

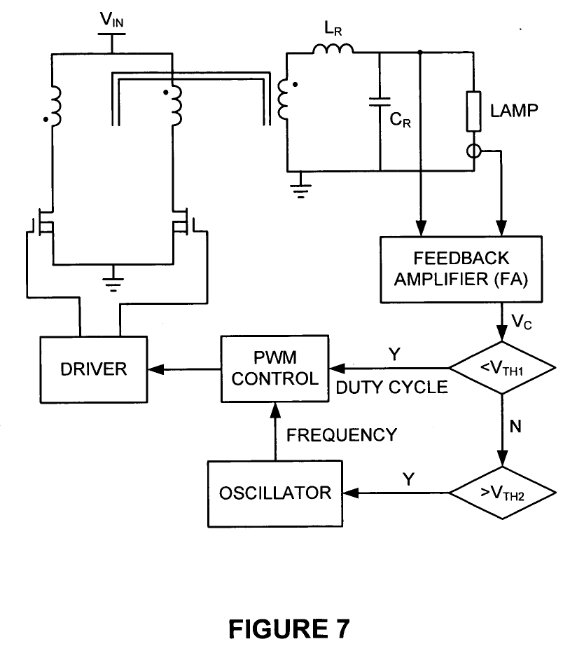

FIG. 7 is a simplified schematic diagram of an alternative embodiment using a push-pull topology. In FIG. 7, on the primary side of the transformer, a first inductor and a first transistor are connected in series between the DC input voltage and the circuit ground and a second inductor and a second transistor are also connected in series between the DC input voltage and the circuit ground. The two transistors in this embodiment are controlled by the gate driver and the first and the second inductors form a transformer with at least one of the windings of the tank loop.

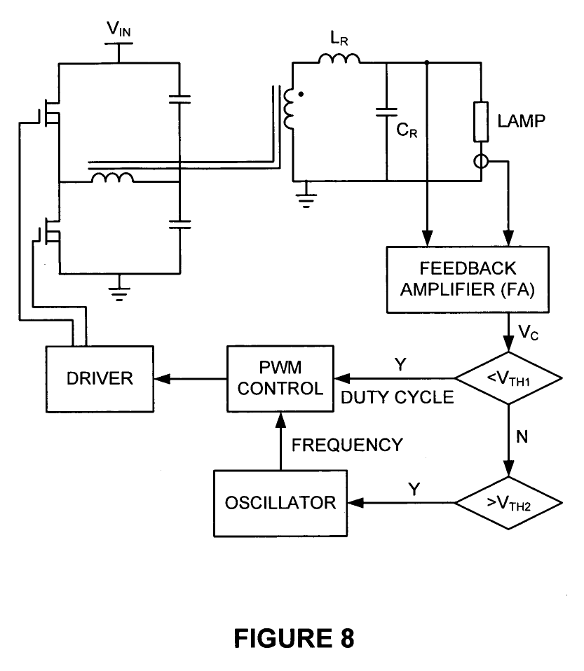

FIG. 8 is a simplified schematic diagram of another embodiment using a half-bridge topology. In FIG. 8, on the primary side of the transformer, a first and a second capacitor are connected in series between the DC input voltage and the circuit ground and a first and a second transistor are also connected in series between the DC input voltage and the circuit ground. An inductor is connected between the connection point of the first and the second capacitors and the connection point of the first and the second transistors. The two transistors in this embodiment are controlled by the gate driver and the inductor forms a transformer with at least one of the windings of the tank loop.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof.

Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize.

The teachings of the invention provided herein can be applied to other systems, not necessarily the system described above. The elements and acts of the various embodiments described above can be combined to provide further embodiments.

Changes can be made to the invention in light of the above Detailed Description. While the above description describes certain embodiments of the invention, and describes the best mode contemplated, no matter how detailed the above appears in text, the invention can be practiced in many ways. Details of the compensation system described above may vary considerably in its implementation details, while still being encompassed by the invention disclosed herein.

As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

I/We claim:

1. A method of converting a DC input voltage to an AC signal, the method comprising:
controllably switching the input voltage ON and OFF in a primary stage to generate a PWM (pulse width modulated) AC signal;
transforming the PWM AC signal to a desired voltage level in a tank circuit of a secondary stage that feeds a load; and
controlling frequency and duty cycle of the PWM AC signal by feeding back a voltage, a current, or the voltage and the current of the secondary stage; wherein the controlling process further comprises:
comparing a fed-back value with at least one reference value; and
generating a control signal that modulates both the frequency and the duty cycle of the PWM AC signal.

2. The method of claim 1, wherein only the duty cycle or the frequency is modulated if the control signal is above a threshold voltage.

3. The circuit of claim 2, wherein there are a first threshold voltage and a second threshold voltage.

4. The circuit of claim 3, wherein only the duty cycle or the frequency is varied if the control signal is below the first threshold voltage.

5. The circuit of claim 4, wherein the other of the duty cycle or the frequency is varied only if the control signal is above the second threshold voltage.

6. A DC to AC power inverter circuit for providing an AC power to a load, the circuit comprising:
a DC input voltage signal;
a switching network comprising at least one switching device to convert the DC input signal to PWM AC waveforms;
a resonant tank circuit for filtering the PWM AC waveforms to drive the load;
and
a feedback part that utilizes measurements of the load voltage, the load current, or both, to drive the switching network; wherein the feedback part comprises:
a feedback amplifier (FA) for comparing at least one load measurement with at least one reference signal to generate a control signal;
a PWM controller for receiving the control signal to generate at least a duty cycle and frequency modulated square-wave signal;
a gate driver for receiving the square-wave signal to drive the switching devices in the switching network; and
a configuration wherein the load measurement is received by the FA, and wherein the FA sends a signal to the PWM controller if the FA output is less than a threshold voltage and sends another signal to an oscillator if the FA output is greater than the threshold voltage.

7. The circuit of claim 6, wherein the switching network is configured in a single-ended topology containing two switching devices with one device being an active device and the other device being a diode or a passive device.

8. The circuit of claim 7, wherein the resonant circuit contains a transformer with two primary windings with at least one end of each winding connecting to one of the two switching devices, and a capacitor coupled between two said primary windings.

9. The circuit of claim 6, wherein the switching network is configured in a half-bridge topology.

10. The circuit of claim 6, wherein the switching network is configured in a push-pull topology.

11. The circuit of claim 6, wherein the switching network is configured in a full-bridge topology.

12. The circuit of claim 6, wherein only the duty cycle is varied if the FA output is below the threshold voltage.

13. The circuit of claim 6, wherein only the switching frequency is varied if the FA output is above the threshold voltage.

14. The circuit of claim 13, wherein the switching frequency is only varied if a load current is sensed.

15. An inverter circuit for powering discharge lamps comprising:
a DC input voltage signal;
a switching network for converting the DC input signal to PWM AC waveforms;
a resonant tank circuit for filtering the PWM AC waveforms to drive the discharge lamps; and
a control circuit for receiving a feedback from the current and voltage of the discharge lamps to drive the switching network and therefore modulate duty cycle and switching frequency of the PWM AC waveforms, wherein only the duty cycle or the switching frequency of the PWM AC waveform is modulated by the control circuit.

16. The circuit of claim 15, wherein the duty cycle and the switching frequency of the PWM AC waveforms are modulated by a common control voltage.

17. The circuit of claim 15, wherein the common control voltage is divided into multiple regions with at least one of these multiple regions controlling only the duty cycle.

18. The circuit of claim 15, wherein the multiple regions contain at least one region controlling only the switching frequency.

19. The circuit of claim 18, wherein the switching frequency varies only if the duty cycle reaches its maximum level.

20. The circuit of claim 15, wherein the multiple regions contain at least one region to control the switching frequency that is only varied before the lamp is struck.
